(19) United States
(12) Patent Application Publication
(10) Pub. No.: US 2006/0028209 A1
(43) Pub. Date: Feb. 9, 2006

(54) Device to identify compression in an automotive engine cylinder

(76) Inventor: Michael Walker, Bellport, NY (US)

Correspondence Address: KELLY & HULME, PC, 323 Mill Road, Westhampton Beach, NY, 11978, US

(21) Appl. No.: 10/910,025

(22) Filed: Aug. 3, 2004

(51) Int. Cl. F02P 17/00

(52) U.S. Cl. 324/378

(57) ABSTRACT

In accordance with the teaching of the present invention, there is herein described and illustrated a testing instrument for measuring cylinder compression at the time of engine spark in that cylinder which instrument includes a compression gauge adapted for insertion into the spark plug aperture of an engine cylinder, a metal indicator needle, means for electrically grounding said needle, a non-electrically conductive annular ring rotatably dispose around the face of the gauge, an electrode mounted to said annular ring and means for operatively connecting said electrode to the engine ignition system.

### BACKGROUND OF THE INVENTION

1. Field of the Invention

This invention relates to a testing instrument for use with an internal combustion engine and, more particularly to a hand held instrument for establishing the relationship between the engine cylinder compression and the spark plug spark.

2. Description of the Prior Art

Internal combustion engine mechanics and other diagnosticians have for many years used compression gauges in analyzing the performance of such an engine, including the diagnosis of engine ignition related problems. While these gauges are simple and easy to use and they provide some useful information, the pressure and compression information the gauge provides by itself, is often not enough to identify the source of a particular problem.

In a gasoline powered internal combustion engine (and other spark ignited engines) typically found in an automobile or truck the relationship between the pressure within any of the cylinders of the engine (i.e.: compression) relative to the timing of the spark arc across the electrode of a spark plug inserted into the cylinder is an important measure of engine performance. When the correct relationship is established, the engine runs smoothly and efficiently. However, if the relationship is not correct, difficulty in operating, or even starting, the engine may occur. As a result, a measurement of the compression in an engine cylinder relative to the spark arc is a useful diagnostic in analyzing certain problems in engine performance.

One attempt to obtain this additional diagnostic information is shown in U.S. Pat. No. 4,292,841, (Wesley). This patent teaches a system and method for detecting the time-rate of change of pressure within an engine cylinder. However, the device described therein is useful mainly for diesel engines and furthermore detects pressure changes and other factors (not pressure at the time of spark) to determine the source of the engine malfunctions.

Another attempt to approach this analysis is shown in U.S. Pat. No. 4,570,124 (Fuchs). Fuchs teaches a device containing a spark chamber for receiving and testing a spark plug under different pressure loads. However, the Fuchs device provides no information relating spark timing to cylinder compression, especially under circumstances where the engine does not start as a result of the spark timing.

It is, therefore, an object of the present invention to provide a testing instrument for measuring compression in an internal combustion engine cylinder at the time the engine ignition system fires the spark plug connected to that cylinder.

It is another object of the present invention to provide such a testing instrument useful in obtaining this data for a cylinder in an engine that is not starting.

It is yet another object of the present invention to provide such an instrument that is simple to use and easy to read.

These and other objects of the present invention shall become apparent from the following specifications, read in conjunction with the appended claims and attached drawings.

### SUMMARY OF THE INVENTION

In accordance with the teaching of the present invention, there is herein described and illustrated a testing instrument for measuring cylinder compression at the time of engine spark in that cylinder which instrument includes a compression gauge adapted for insertion into the spark plug aperture of an engine cylinder, a metal indicator needle, means for electrically grounding said needle, a non-electrically conductive annular ring rotatably dispose around the face of the gauge, an electrode mounted to said annular ring and means for operatively connecting said electrode to the engine ignition system.

In operation, the testing instrument of the present invention is inserted into the cylinder by inserting the adapted end of the gauge into the spark plug aperture. The engine is then operated either by starting the engine in the conventional way (by a key inserted into the ignition switch) or manually operating the engine drive shaft. The pressure in the cylinder at any given point may then be observed on the pressure gauge. The annular ring may then be rotated to position the electrode close enough to the needle such that a spark arc is observed from the electrode to the needle. Through small adjustments of the annular ring and based on the brightness and intensity of the spark produced, the pressure in the cylinder at the time of spark may be determined.

### BRIEF DESCRIPTION OF THE DRAWINGS

FIG. 1 is a partly schematic view of the instrument of the present invention;

FIG. 2 is a perspective view of the instrument of the present invention; and

FIG. 3 is an exploded side view of the instrument of the present invention.

### DETAILED DESCRIPTION OF THE PRESENT INVENTION

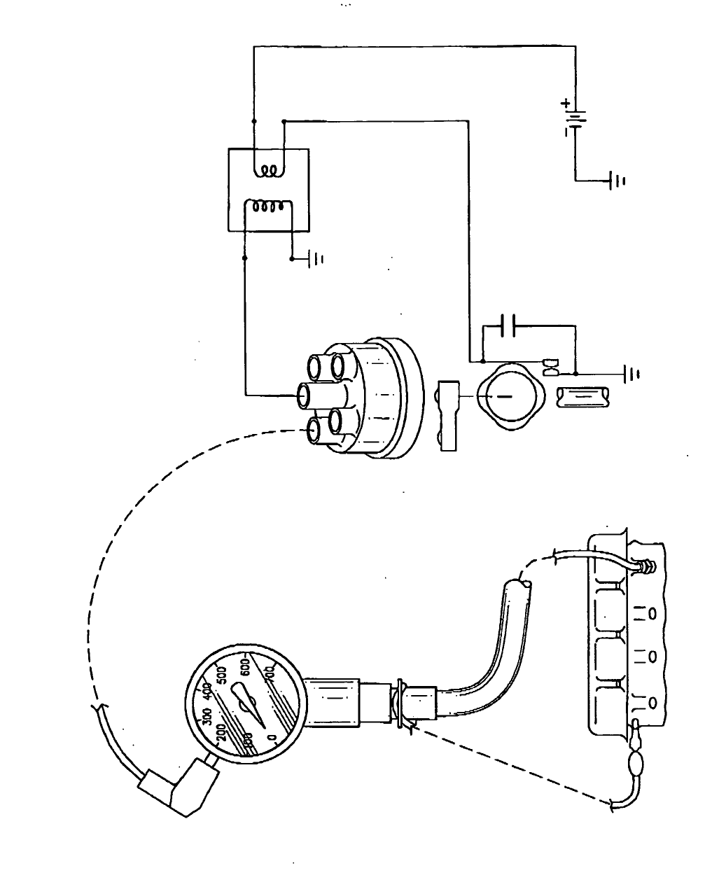

Referring to the drawings, the engine testing instrument of the present invention is generally designated as numeral 10. In FIG. 1, the instrument 10, constructed in accordance with the present invention, is shown in conjunction with and electrically connected to the conventional ignition system 12 of a multi cylinder internal combustion engine 14 and adapted to connect to the spark plug aperture 16 of one of the engine cylinders 18.

The instrument is comprised of a pressure gauge 20, an annular ring 24 rotatably mounted around gauge 20, an electrode 36 mounted on said ring 20, an indicator needle 20 and means for electrically grounding the indicator needle 20 and means for electrically connecting electrode 26 to the ignition system 12.

The pressure gauge 20 is adapted for connection to cylinder 18 by providing a threaded gauge stem 21 sized for being sealingly threaded into spark plug aperture 16. The gauge 20 will thereby indicate the pressure in the cylinder, in a manner known in the art. Changes in pressure in the cylinder 18 will be reflected by movement of gauge needle 22 relative to an indicator band 23 disposed about the needle.

The indicator band 23 is generally composed of a series of gradations 25 with numbers indicted adjacent thereto, the numbers corresponding to the actual pressure in the cylinder as determined by the location of needle relative to the numbered gradient.

As also indicated above, the instrument 10 of the present invention is comprised of an annular ring 24 made of a material that will not conduct electricity. The ring 24 is rotatably mounted to pressure gauge 20 and disposal around the indicator needle 20 and indicates band 23 such that the ring 24 may be rotated relative to said needle 20 and indicates band 23.

The ring 24 contains an electrode 36 mounted thereto and located on the inside edge 27 of ring 24. The electrode 36 is oriented such that it may be located, by rotating said ring 24, in close proximity to the indicating end of needle 20. The electrode 36 also includes an electrical connection 38 for making an electrical connection between the electrode 36 and the engine ignition system 12 as described in more detail below.

Finally, the instrument 10 of the present invention is provided with means for electrically grounding the needle 20 such that a complete electrical current may be created under certain engine operation conditions. This grounding means is most opportunely provided via the metal components of the gauge physically contacting the metal gauge stem 21 which is in physical contact with the engine block within which the spark plug aperture 16 is found.

As indicated above, the test instrument 10 of the present invention is connected electrically to the engine ignition system 12. This is accomplished through the use of the spark plug wire 32 by connecting the spark plug receiving end 34 of said wire 32 to electrode connector 38 whereby any electrical impulse generated by the ignition system 12 may be conducted from said ignition system 12 to electrode 36.

It will be clear to those skilled in the art that the instrument 10 of the present invention may be used with any ignition system 12 that generates pulsed electrical signals to the engine cylinder spark plugs such as a system that include a rotor assembly with break points, a solid state breakerless system and the like.

After connecting the instrument 10 to the cylinder 18 by the adapted stem 21 and to the ignition system 12, as described above, the grounding means 15 of the present invention is accomplished by the above metal to metal contact between the gauge and the engine block. However, this may be accomplished by any other means known in the art.

The test instrument 10 when connected to the engine 14 and ignition system 12 as described above will allow direct observation of the actual cylinder compression at the time of spark are in the cylinder as generated by a spark plug therein.

With the instrument 10 connected as described, the engine 14 is started either as normal or manually (if the engine will not “turnover”) such that any electrical impulses generated by the ignition system 12 and communicated to spark plug wire 32 will cause an electric spark 40 to occur when the electrode 36 is adjacent to gauge needle 22, the appropriate proximity of the needle to the electrode being determined by the intensity, duration and color of the spark. By adjusting the location of the electrode 36 around the gauge 20 based on the cylinder compression as displayed on the gauge 20, the actual cylinder pressure at the time of the spark may be accurately determined. This information may then be used to determine engine adjustment necessary to require engine operation.

Thus it will be seen that a hand held instrument for determining the relationship between cylinder compression and spark plug spark is provided that is easy to use without other specialized or auxiliary equipment. As will be apparent to those skilled in the art, various modification and adaptations of the above described instrument will be really apparent and will, therefore, be with the special and scope of the present invention, the scope of which is defined in the appended claims.

What is claimed is:

1. A testing instrument establishing the relationship between engine cylinder compression and the timing of spark ignition for use on a spark ignited automotive engine of the type having a plurality of cylinders each cylinder having an aperture extending from the cylinder to the exterior of the engine, said aperture being adapted to receive and sealingly engage a sparking device such as a spark plug or glow plug, said instrument comprising:
a pressure gauge operationally connected to and adapted for insertion into the spark plug aperture of said engine cylinder;
an electrically conductive indicator needle forming a part of said gauge, said needle indicating the pressure in said cylinder at any given point in time;
means for electrically grounding said indicator needle;
a non-electrically conductive annular ring rotatable disposed around the pressure gauge;
an electrode mounted to said ring; and
means for electrically connecting said electrode to the engine ignition system.
